(19) United States
(12) Patent Application Publication
(10) Pub. No.: US 2026/0313032 A1
(43) Pub. Date: Oct. 8, 2026

(54) DATA TRANSMISSION METHOD AND APPARATUS, ELECTRONIC DEVICE, AND STORAGE MEDIUM

(71) Applicant: Douyin Vision Co., Ltd., Beijing (CN)

(72) Inventors: Sheng WANG, Beijing (CN); Feng YUAN, Beijing (CN); Chao WU, Beijing (CN); Yu ZHENG, Beijing (CN)

(21) Appl. No.: 19/136,800

(22) PCT Filed: Mar. 20, 2024
(86) PCT No.: PCT/CN2024/082653

§ 371 Date: Jun. 6, 2025

(30) Foreign Application Priority Data
Apr. 12, 2023 (CN) 202310389329.0

(51) Int. Cl. H04L 67/141; H04L 67/06; H04L 67/55

(52) U.S. Cl. CPC H04L 67/141; H04L 67/06; H04L 67/55

(57) ABSTRACT

The present disclosure provides a data transmission method and apparatus, an electronic device, and a storage medium. The data transmission method includes: establishing a network communication connection with a terminal device according to historical connection establishment information, wherein the historical connection establishment information is historical information for connection between the server and the terminal device; receiving a control instruction from the terminal device based on the network communication connection, wherein the control instruction is configured to control a process of a first application on the server, and the first application is a version of an application on the server; and pushing, to the terminal device, a data stream corresponding to the control instruction based on the network communication connection, wherein the data stream is configured for loading and/or running a second application on the terminal device, and the second application is a version of the application on the terminal device.

### CROSS-REFERENCE TO RELATED APPLICATION(S)

The present application is based on and claims priority to Chinese Patent Application No. 202310389329.0, filed on Apr. 12, 2023 and entitled “DATA TRANSMISSION METHOD AND APPARATUS, ELECTRONIC DEVICE, AND STORAGE MEDIUM”, which is incorporated herein by reference in its entirety.

### TECHNICAL FIELD

The present disclosure relates to the field of communication, and more specifically, to a data transmission method and apparatus, an electronic device, and a storage medium.

### BACKGROUND

In a real-time communication scenario (for example, a cloud game scenario, a live streaming scenario, a video conference scenario, or the like), data and control instructions are generally transmitted based on Web Real-Time Communication (WebRTC).

### SUMMARY

In order to solve the problem that the real-time communication based on WebRTC affects the loading or running of an application on a terminal device, the present disclosure provides a data transmission method and apparatus, an electronic device, and a storage medium, so as to achieve a technical objective of optimizing user experience.

In order to solve one or more problems existing in the related art, the present disclosure can provide a data transmission method, which is applied to a server, and the data transmission method includes:
establishing a network communication connection with a terminal device according to historical connection establishment information, wherein the historical connection establishment information is historical information for connection between the server and the terminal device;
receiving a control instruction from the terminal device based on the network communication connection, wherein the control instruction is configured to control a process of a first application on the server, and the first application is a version of an application on the server; and
pushing, to the terminal device, a data stream corresponding to the control instruction based on the network communication connection, wherein the data stream is configured for loading and/or running a second application on the terminal device, and the second application is a version of the application on the terminal device.

In order to solve one or more problems existing in the related art, the present disclosure further provides a data transmission method, which is applied to a terminal device, and the data transmission method includes:
establishing a network communication connection with a server, wherein the network communication connection is established according to historical connection establishment information in the server, and the historical connection establishment information is historical information for connection between the server and the terminal device;
sending a control instruction to the server based on the network communication connection, wherein the control instruction is configured to control a process of a first application on the server, and the first application is a version of an application on the server; and
receiving a data stream corresponding to the control instruction from the server based on the network communication connection, wherein the data stream is configured for loading and/or running a second application on the terminal device, and the second application is a version of the application on the terminal device.

In order to solve one or more problems existing in the related art, the present disclosure further provides a data transmission apparatus, which is applied to a server, and the data transmission apparatus includes:
a first connection module, configured to establish a network communication connection with a terminal device according to historical connection establishment information, wherein the historical connection establishment information is historical information for connection between the server and the terminal device;
a first reception module, configured to receive a control instruction from the terminal device based on the network communication connection, wherein the control instruction is configured to control a process of a first application on the server, and the first application is a version of an application on the server; and
a data pushing module, configured to push, to the terminal device, a data stream corresponding to the control instruction based on the network communication connection, wherein the data stream is configured for loading and/or running a second application on the terminal device, and the second application is a version of the application on the terminal device.

In order to solve one or more problems existing in the related art, the present disclosure further provides a data transmission apparatus, which is applied to a terminal device, and the data transmission apparatus includes:
a second connection module, configured to establish a network communication connection with a server, wherein the network communication connection is established according to historical connection establishment information in the server, and the historical connection establishment information is historical information for connection between the server and the terminal device;
an instruction sending module, configured to send a control instruction to the server based on the network communication connection, wherein the control instruction is configured to control a process of a first application on the server, and the first application is a version of an application on the server; and
a data reception module, configured to receive a data stream corresponding to the control instruction from the server based on the network communication connection, wherein the data stream is configured for loading and/or running a second application on the terminal device, and the second application is a version of the application on the terminal device.

In order to solve one or more problems existing in the related art, the present disclosure can further provide an electronic device, including a memory and a processor, wherein the memory stores computer-readable instructions, and the computer-readable instructions, when executed by the processor, cause the processor to perform the data transmission method according to any embodiment of the present disclosure.

In order to solve one or more problems existing in the related art, the present disclosure further provides a storage medium storing computer-readable instructions, wherein the computer-readable instructions, when executed by one or more processors, cause the one or more processors to perform the data transmission method according to any embodiment of the present disclosure.

### BRIEF DESCRIPTION OF THE DRAWINGS

FIG. 1 is a flowchart of a data transmission method applied to a server according to one or more embodiments of the present disclosure.

FIG. 2 is a flowchart of pushing, based on a network communication connection, a data stream corresponding to a control instruction to a terminal device according to one or more embodiments of the present disclosure.

FIG. 3 is a flowchart of controlling, based on a control instruction, a process of a first application according to one or more embodiments of the present disclosure.

FIG. 4 is a schematic diagram of an interaction procedure between a terminal device and a server according to one or more embodiments of the present disclosure.

FIG. 5 is a flowchart of a data transmission method applied to a terminal device according to one or more embodiments of the present disclosure.

FIG. 6 is a schematic structural diagram of a data transmission apparatus integrated in a server according to one or more embodiments of the present disclosure.

FIG. 7 is a schematic structural diagram of a data transmission apparatus integrated in a terminal device according to one or more embodiments of the present disclosure.

FIG. 8 is a schematic structural diagram of an internal structure of an electronic device according to one or more embodiments of the present disclosure.

### DETAILED DESCRIPTION OF EMBODIMENTS

In a process where a terminal device and a server perform real-time communication based on WebRTC, the related art requires using different communication connections correspondingly in transmission processes of different types of content. However, the more times the communication connection is established and the longer time spent when the single communication connection is established, the longer the total time the connection establishment process between the terminal device and the server is, which often affects the loading and/or running of the application on the terminal device. In particular, there is a problem that the loading time of the first frame picture is excessively long, which seriously affects the user experience.

Compared with the related art, the embodiments of the present disclosure can significantly reduce the time occupied by the establishment of the network communication connection between the terminal device and the server based on the historical connection establishment information, and send a control instruction from the terminal device to the server and push a data stream from the server to the terminal device based on the same established network communication connection. It can be seen that the embodiments of the present disclosure can also reduce the number of times of establishing the communication connection, so that the present disclosure significantly reduces the total time of the connection establishment process compared with the related art, thereby optimizing the loading and/or running process of the second application on the terminal device, improving the user experience, and increasing user satisfaction.

In the related art, there are problems in the real-time communication based on WebRTC, such as a large number of times of connection establishment between the terminal device and the server, and a long time for a single connection establishment, resulting in poor user experience. Taking the network transmission scheme of cloud games as an example, peer-to-peer connection (P2P) connection establishment based on WebRTC is generally required, to transmit network-transmitted game pictures, and Data Channel connection establishment is performed, to transmit control instructions. It can be seen that the network transmission scheme in the related art requires using different communication connections correspondingly in different interaction processes, which has problems of many interactions between the terminal device and the server and a long total time of connection establishment caused by a long single connection establishment time and a large number of connection establishment times.

The cloud game is a game based on cloud computing. In a running mode of the cloud game, a running entity of a game program and a presentation entity of a game picture are separated. For example, the running entity of the game program is generally a server, and the presentation entity of the game picture is generally a terminal device. The running entity of the game program is configured to render the game picture, and then send data related to the rendered game picture to the presentation entity of the game picture through a network. In addition to transmitting the data related to the game picture through the network, a control instruction related to the game is also often transmitted. In the cloud game scenario, a corresponding network communication connection needs to be created before instruction transmission, and a corresponding network communication connection needs to be created before data stream transmission. In particular, in the scenario where the cloud game starts and the network is restored after an interruption during the running of the cloud game, the network transmission scheme based on WebRTC in the related art will cause a great impact on the start and running of the cloud game, resulting in problems such as poor user experience of the cloud game and low user satisfaction with the cloud game. In view of this, the present disclosure provides a data transmission method and apparatus, an electronic device, and a storage medium, and the following describes various embodiments of the present disclosure in detail.

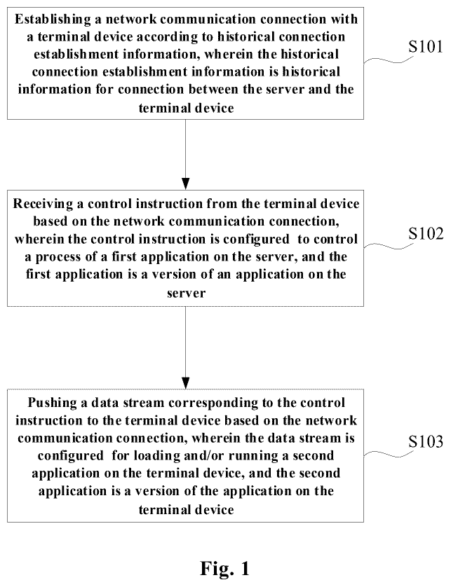

As shown in FIG. 1, one or more embodiments of the present disclosure provide a data transmission method, which is applied to a server, and the data transmission method includes but is not limited to step S101 to step S103.

Step S101: establishing a network communication connection with a terminal device according to historical connection establishment information, wherein the historical connection establishment information is historical information for connection between the server and the terminal device.

The historical connection establishment information specifically involved in this embodiment may include, but is not limited to, a terminal device Identity document (ID), a terminal device Internet Protocol (IP) address, terminal device configuration information, and the like.

The terminal device involved in this embodiment may include one or more of a terminal such as a smart phone, a tablet computer, a Personal Computer (PC), a television, a wearable device, and the like.

In one or more embodiments of the present disclosure, establishing the network communication connection with the terminal device according to the historical connection establishment information includes: the server can query the historical connection establishment information with a connection establishment parameter sent by the terminal device, and if the historical connection establishment information matching the connection establishment parameter is found, it is determined that the terminal device has been connected with the server, which indicates that the connection is successful and there is no need to reply to the connection establishment parameter; however, if the historical connection establishment information matching the connection establishment parameter is not found, it is determined that the terminal device has not been connected with the server, and a new connection establishment parameter is replied, where the connection establishment parameter includes handshake information.

The network communication connection between the terminal device and the server involved in this embodiment is specifically Web Transport, which helps to reduce the time of establishing a connection between the application startup process on the terminal device and the server.

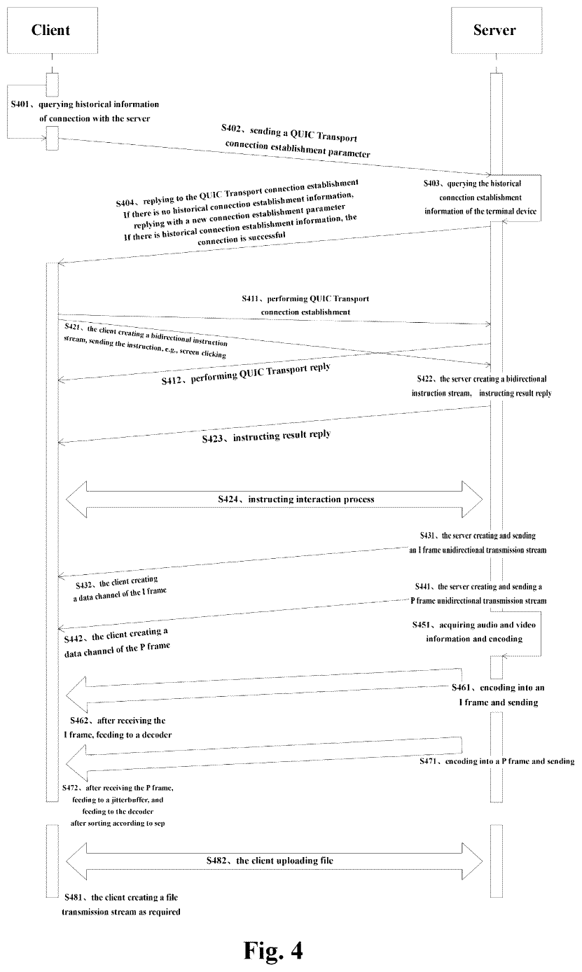

As shown in FIG. 4, the specific process of establishing the network communication connection between the terminal device and the server in this embodiment may include but is not limited to the following steps.

S401: the terminal device queries historical information for connection with the server.

S402: the terminal device sends a Quick UDP Internet Connection (QUIC) Transport connection establishment parameter to the server according to the found historical information for connection with the server. The connection establishment parameter includes, for example, config_id, transport_parameters, idle_timeout, max_stream_number, etc., where config_id (configuration identification) represents public key information configured for the terminal device to shake hands with the server, transport parameters (transmission parameter) represents a transmission parameter of a cached historical connection, such as information such as an initial window size; idle_timeout represents an idle timeout, and the connection is automatically disconnected after the idle time without data interaction exceeds idle_timeout; max_stream_number represents the maximum number of multiplexed data streams, and data streams exceeding this number cannot be successfully created in one connection.

S403: the server queries the historical connection establishment information of the terminal device. If the historical connection establishment information matching the connection establishment parameter is found, it is determined that the terminal device has been connected with the server, which indicates that the connection is successful; and if the historical connection establishment information matching the connection establishment parameter is not found, it is determined that the terminal device has not been connected with the server.

S404: the server performs a QUIC Transport connection establishment reply, which may specifically include: if there is no historical connection establishment information, replying with a new connection establishment parameter; and if there is historical connection establishment information, the connection is successful.

S411: the terminal device sends a request for QUIC Transport connection establishment to the server.

S412: the QUIC Transport replies that the connection is successful.

Step S102: receiving a control instruction from the terminal device based on the network communication connection, wherein the control instruction is configured to control a process of a first application on the server, and the first application is a version of an application on the server.

The process involved in the present disclosure specifically refers to one running activity of a program in the terminal device on a certain data set, and is a basic unit for resource allocation by the operating system on the terminal device.

In this embodiment, the content transmitted over the network includes the control instruction, and the control instruction may be a control instruction related to live streaming, a control instruction related to a video conference, or a control instruction related to a cloud game. Taking the cloud game as an example, the control instruction in this embodiment may include, but is not limited to, a game start instruction, a game operation instruction, and the like.

Taking the game operation instruction as an example, the control instruction may be triggered by operations such as screen clicking, rotating, and definition selecting by the user.

Taking the game start instruction as an example, this embodiment can greatly reduce the time consumed in the loading process of the first frame picture of the cloud game, so this embodiment can greatly improve the start-up speed of the cloud game.

As shown in FIG. 4, step S102 in the embodiment of the present disclosure may include but is not limited to step S421 to step S424.

In S421, the terminal device creates a bidirectional instruction stream based on an operation of the user, and sends an instruction to the server, where the user operation may be, for example, screen clicking. The process of creating the bidirectional instruction stream includes: creating a bidirectional reliable stream (Bidirection Stream) object on the basis of the established network communication connection.

The bidirectional reliable stream (Bidirection Stream) refers to a data stream that can be sent and received by both the terminal device and the server.

In an optional embodiment of the present disclosure, step S421 can be executed simultaneously with step S411, which helps to further shorten the instruction interaction time.

In S422, the server creates a bidirectional instruction stream object, and instructs the result to reply to the above user operation such as screen clicking.

In S423, the server replies with the instruction result. Whether it is the terminal device or the server, when an instruction needs to be transmitted, data is sent and received between the terminal device and the server through the bidirectional reliable stream (Bidirection Stream).

In S424, a subsequent instruction interaction process may be performed. The present disclosure can be used in scenarios such as live streaming, video conferences, or cloud games. In the cloud game scenario, taking a start instruction as an example, after receiving the start instruction, the server starts a local game, and performs the subsequent game process collection process of audio and video information. Taking a ending (Game Stop) instruction as an example, after receiving the stop instruction sent by the terminal device, the server closes the audio and video push stream and closes the game process.

Step S103: pushing, to the terminal device, a data stream corresponding to the control instruction based on the network communication connection, where the data stream is configured for loading and/or running a second application on the terminal device, and the second application is a version of the application on the terminal device.

In the embodiment of the present disclosure, in order to better realize the function of the application, the first application is run on the server, and the second application is run on the terminal device.

The data stream in this embodiment specifically includes an audio and video data stream, and the content transmitted over the network includes the audio and video data stream.

The terminal device is configured with a separate first encoding and decoding module, and the first encoding and decoding module is configured to decode the received data stream to decode audio and video information. The first encoding and decoding module may include an encoder and a decoder.

The second application may be installed on the terminal device, and the application involved in this embodiment may be, for example, a cloud game program, a video conference program, a live streaming program, or the like.

The present disclosure can transmit both the control instruction and the audio and video data stream based on one network communication connection, and the present disclosure can reuse the channels created by the same network communication connection, which avoids the problem in the related art that the network communication connection is established multiple times to transmit different content.

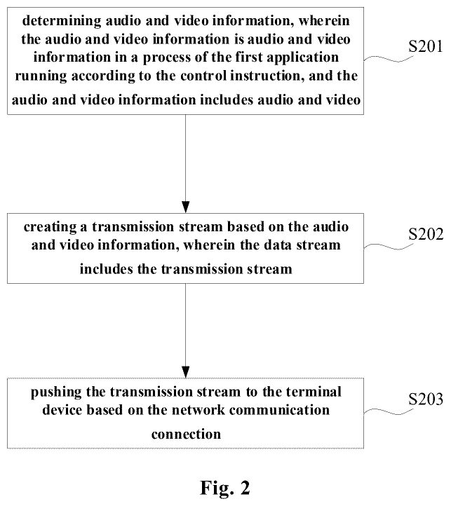

As shown in FIG. 2, in one or more optional embodiments of the present disclosure, pushing the data stream corresponding to the control instruction to the terminal device based on the network communication connection includes but is not limited to step S201 to step S203.

Step S201: determining audio and video information, wherein the audio and video information is audio and video information in a process of the first application running according to the control instruction, and the audio and video information includes audio and video.

In this embodiment, the audio and video information is determined by acquiring the audio and video information, and the audio and video information is the audio and video information in the process of the first application running according to the control instruction.

The audio and video information in this embodiment is specifically the audio and video information of the first application running on the server, and the acquisition manner of the audio and video information is real-time acquisition.

Step S202: creating a transmission stream based on the audio and video information, wherein the data stream includes the transmission stream.

In this embodiment, a multi-frame transmission stream is created by using the audio and video information, wherein the data stream is specifically a multi-frame unidirectional transmission stream.

The unidirectional transmission stream may include, for example, a video transmission stream and an audio transmission stream, and/or an audio and video mixed stream.

Step S203: pushing the transmission stream to the terminal device based on the network communication connection.

In this embodiment, the server specifically pushes the multi-frame unidirectional transmission stream to the terminal device based on the network communication connection.

In the above embodiments of the present disclosure, the unidirectional transmission stream for transmission is created based on the acquired audio and video, and the unidirectional transmission stream is more suitable for network transmission, which helps to improve the efficiency of audio and video information transmission.

As shown in FIG. 4, in one or more optional embodiments of the present disclosure, creating the transmission stream based on the audio and video information includes: encoding the audio and video information into a first transmission stream and a second transmission stream, wherein the first transmission stream is configured to be transmitted to the terminal device based on a reliable transmission manner, the second transmission stream is configured to be transmitted to the terminal device based on a non-reliable transmission manner, and the transmission stream includes the first transmission stream and the second transmission stream.

The first transmission stream includes a plurality of data packages for transmission, and the second transmission stream includes a plurality of data packages for transmission.

In this embodiment, the server is configured with a separate second encoding and decoding module, and the second encoding and decoding module is configured to encode the acquired audio and video information.

Specifically, the second encoding and decoding module in this embodiment can be configured to encode the audio and video information into the first transmission stream and the second transmission stream, and the encoding process includes a data compression process of the audio and video information, wherein the data format of the first transmission stream and the second transmission stream may be, for example, AVI, H265, etc., and the second encoding and decoding module includes an encoder and a decoder.

Based on the transmission scheme of Web Transport, this embodiment can effectively avoid the coupling problem between the transmission protocol and the encoding and decoding protocol in WebRTC, so that the optimization of the transmission layer and the optimization of the audio and video encoding and decoding encapsulation can be performed independently.

With the transmission policy of combining reliable transmission and unreliable transmission, the present disclosure can ensure that the first transmission stream is reliably transmitted from the server to the terminal device, and the second transmission stream is transmitted from the server to the terminal device as much as possible, thereby preferentially ensuring the smoothness of the video and discarding data packages with low importance. The biggest advantage of this method is that even if the network environment is unstable, for example, the network quality suddenly deteriorates, this embodiment can preferentially ensure that the first transmission stream is transmitted from the server to the terminal device, thereby maximizing the normal presentation of the game picture on the terminal device.

As shown in FIG. 4, in one or more optional embodiments of the present disclosure, the first transmission stream is an Intra coded frame (I frame) unidirectional transmission stream, and the I frame transmission stream is configured to be transmitted to the terminal device based on a first transmission protocol; and the second transmission stream is a Predictive coded frame (P frame) unidirectional transmission stream, and the P frame transmission stream is configured to be transmitted to the terminal device based on a second transmission protocol. The priority of the first transmission protocol is higher than the priority of the second transmission protocol, which indicates that the transmission priority of the I frame unidirectional transmission stream is higher than the transmission priority of the P frame unidirectional transmission stream. The audio and video information is encoded in such a manner that several P frames are set after one I frame, for example, an encoding output sequence such as IPPPIPPP.

For the server, both the I frame unidirectional transmission stream and the P frame unidirectional transmission stream in this embodiment are unidirectional transmission streams from the server to the terminal device.

More specifically, in this embodiment, the data stream, the control instruction, and the like may be transmitted through Quick UDP Internet Connection (QUIC) Transport, where UDP refers to User Datagram Protocol.

In this embodiment, the I frame output by the second encoding and decoding module is transmitted through the QUIC Unidirection Stream (unidirectional reliable stream) with the highest priority, so as to ensure that the I frame as a key frame is transmitted with the highest priority and reliably in the limited network of the user. For a non-highest priority data stream (P frame), the present embodiment employs a best-effort manner, so that it is transmitted with low priority (or low priority transmission) in the limited network of the user or discarded, in the present embodiment, the P frame output by the second encoding and decoding module is transmitted through the QUIC Datagrams (unreliable datagrams) with the second highest priority.

In this embodiment, the terminal device can still meet the playback requirement of the terminal device in the special case where only the I frame is received, so as to improve the application experience in the case of poor network environment, for example, to improve the experience of cloud games, video conferences, or live streaming scenarios.

For the terminal device, the received P frame is processed by jitterbuffer (jitter buffer) and sorted and then fed to the decoder in the first encoding and decoding module, and after receiving the P frame, the decoder will decode with reference to the I frame, and then render and display.

In addition, based on the manner of preferentially transmitting the I frame, the smoothness of the cloud game picture of the terminal device can be ensured, so as to avoid the problem that the cloud game picture is prone to be stuck in the related art.

As shown in FIG. 4, step S103 in this embodiment may include but is not limited to step S431 to step S472.

In S431, the server creates an I frame unidirectional transmission stream and sends it.

In S432, the terminal device creates a data channel of the I frame.

The server writes the video I frame data output by the encoder into the created unidirectional stream, and the web transport protocol stack will send it out; and the terminal device passively creates the unidirectional stream data channel after receiving the data received by the stream.

In S441, the server creates a P frame unidirectional transmission stream and sends it.

In S442, the terminal device creates a data channel of the P frame.

In S451, the server acquires the audio and video information, and encodes the acquired audio and video information.

In S461, the server encodes the audio and video information into an I frame, and then sends it to the terminal device.

In S462, after receiving the I frame, the terminal device feeds the I frame to a decoder.

In S471, the server encodes the audio and video information into a P frame, and then sends it to the terminal device.

In S472, after receiving the P frame, the terminal device feeds the P frame to a jitterbuffer (jitter buffer), sorts the P frame according to sep (bucket sorting), and then feeds the P frame to the decoder.

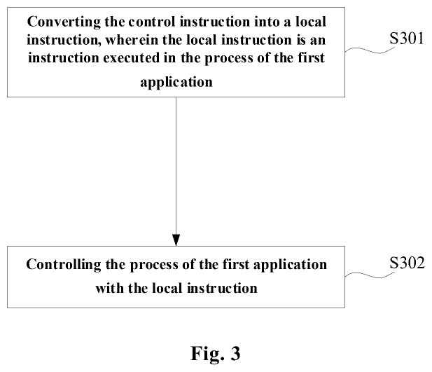

As shown in FIG. 3, in one or more optional embodiments of the present disclosure, the data transmission method further includes but is not limited to step S301 to step S302.

Step S301: converting the control instruction into a local instruction, wherein the local instruction is an instruction executed in the process of the first application.

The local instruction in this embodiment refers to an instruction that can be directly executed in the process of the first application without parsing.

Step S302: controlling the process of the first application with the local instruction.

During specific implementation, in this embodiment, the local instruction may be fed to the process of the first application running on the server, and the local instruction is executed in the process of the first application.

Based on the manner of converting the control instruction into the local instruction of the server, the present disclosure can also directly feed the local instruction to the process of the first application, thereby significantly improving the effectiveness and reliability of the control instruction execution.

In one or more optional embodiments of the present disclosure, the data transmission method further includes: sending a specified instruction to the terminal device, where the specified instruction is configured to control a state of the second application.

The server sends the specified instruction to the terminal device, for example, the server may allow the terminal device to change the decoding parameter, and the server notifies the terminal device of information in real time, such as transfer of multi-person control rights and a mute voice for the whole audience; and the server sends location information of the cloud game instance to the terminal device.

In an optional embodiment of the present disclosure, receiving the control instruction from the terminal device based on the network communication connection includes: receiving the control instruction from the terminal device based on a third transmission protocol; and the data transmission method further includes: receiving a file package from the terminal device based on a fourth transmission protocol, where a plurality of the file packages form a file uploaded by the terminal device; where a priority of the second transmission protocol is higher than a priority of the third transmission protocol, and the priority of the third transmission protocol is higher than a priority of the fourth transmission protocol.

Preferably, the first transmission protocol is a unidirectional reliable stream transmission protocol; and/or, the second transmission protocol is an unreliable datagram transmission protocol; and/or, the third transmission protocol is a bidirectional reliable stream transmission protocol; and/or, the fourth transmission protocol is a network transmission sending stream transmission protocol. The unidirectional reliable stream transmission protocol in this embodiment is, for example, a QUIC Unidirection Stream, the unreliable datagram transmission protocol is, for example, a QUIC Datagrams, the bidirectional reliable stream transmission protocol is, for example, a QUIC Bidirection Stream, and the network transmission sending stream transmission protocol is, for example, a WebTransportSendStream.

By transmitting various types of data based on the above various transmission protocols, the present disclosure can reliably ensure that the I frame transmission stream, the P frame transmission stream, the control instruction, and the file are transmitted in the order of priority from high to low, thereby further optimizing the loading and/or running of the application on the terminal device.

Specifically, the process of uploading the file by the terminal device may include: S481, the terminal device creates a file transmission stream as required; and S482, the terminal device uploads the file.

Taking the cloud game scenario as an example, the terminal device sends a game archive file, a game account login-free file, and the like to the server, and the server sends a wonderful game screenshot, a game archive file, and the like to the terminal device.

In this embodiment, the file is uploaded from the terminal device to the server through the WebTransportSendStream with the lowest priority.

In this embodiment, the file package may be transmitted through an additional transmission channel, so as to realize the function of the terminal device transmitting the file to the server. Certainly, on the basis of the present disclosure, the function of the server pushing content to the terminal device can also be realized.

The present disclosure can also realize the file transmission function in the cloud game scenario, which enriches the functional applications in the cloud game scenario.

Combined with the above embodiments, in the embodiment of the present disclosure, the control instruction and the specified instruction can be transmitted through the QUIC Bidirection Stream (bidirectional reliable stream), so as to realize the instruction interaction function between the terminal device and the server.

In some embodiments, for example, in extreme network conditions such as very poor network environment quality of the terminal device, the instruction transmission process may be delayed, so as to ensure that the key frame of the video is played on the terminal device.

In the embodiment of the present disclosure, the priority of the audio and video data stream, the control instruction, and the file is divided, so as to satisfy the continuous and stable running of the cloud game picture of the terminal device based on the data stream with higher priority, realize the interaction function of the control instruction based on the second highest priority, and satisfy the user's file transmission function in the cloud game scenario on the basis of the above functions.

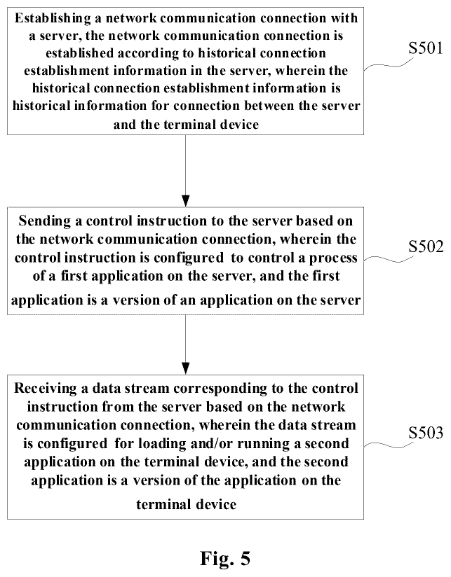

As shown in FIG. 5, based on the same inventive concept as the data transmission method applied to the server in the present disclosure, one or more embodiments of the present disclosure can further provide a data transmission method, which is applied to a terminal device.

The data transmission method applied to the terminal device may include but is not limited to step S501 to step S503.

Step S501: establishing a network communication connection with a server, wherein the network communication connection is established according to historical connection establishment information in the server, and the historical connection establishment information is historical information for connection between the server and the terminal device.

Step S502: sending a control instruction to the server based on the network communication connection, wherein the control instruction is configured to control a process of a first application on the server, and the first application is a version of an application on the server.

In an optional embodiment of the present disclosure, the first application may be a first cloud game, and the control instruction is configured to control a process of the first cloud game on the server.

Step S503: receiving a data stream corresponding to the control instruction from the server based on the network communication connection, wherein the data stream is configured for loading and/or running a second application on the terminal device, and the second application is a version of the application on the terminal device.

In an optional embodiment of the present disclosure, the second application may be a second cloud game, and the data stream may be configured for loading and/or running the second cloud game on the terminal device.

Optionally, the server is configured to determine audio and video information, where the audio and video information is audio and video information in a process of the first application running according to the control instruction, and the audio and video information includes audio and video; the server is configured to create a transmission stream based on the audio and video information, where the data stream includes the transmission stream; and the server is configured to push the transmission stream to the terminal device based on the network communication connection. The server may be configured to determine the audio and video information by acquiring the audio and video information.

Optionally, the server is further configured to encode the audio and video information into a first transmission stream and a second transmission stream, where the first transmission stream is configured to be transmitted to the terminal device based on a reliable transmission manner, the second transmission stream is configured to be transmitted to the terminal device based on a non-reliable transmission manner, and the transmission stream includes the first transmission stream and the second transmission stream.

Optionally, the first transmission stream is an I frame transmission stream, and the I frame transmission stream is configured to be transmitted to the terminal device based on a first transmission protocol; and the second transmission stream is a P frame transmission stream, and the P frame transmission stream is configured to be transmitted to the terminal device based on a second transmission protocol; where a priority of the first transmission protocol is higher than a priority of the second transmission protocol.

Optionally, the server is configured to convert the control instruction into a local instruction, where the local instruction is an instruction executed in the process of the first application; and the server is configured to control the process of the first application with the local instruction.

Optionally, the data transmission method further includes: receiving a specified instruction from the server, wherein the specified instruction is configured to control a state of the second application.

Optionally, the server is configured to receive the control instruction from the terminal device based on a third transmission protocol; and the data transmission method further includes: sending a file package to the server based on a fourth transmission protocol, where a plurality of the file packages form a file uploaded by the terminal device.

The priority of the second transmission protocol is higher than the priority of the third transmission protocol, and the priority of the third transmission protocol is higher than the priority of the fourth transmission protocol.

Preferably, the first transmission protocol is a unidirectional reliable stream transmission protocol; and/or, the second transmission protocol is an unreliable datagram transmission protocol; and/or, the third transmission protocol is a bidirectional reliable stream transmission protocol; and/or, the fourth transmission protocol is a network transmission sending stream transmission protocol. The unidirectional reliable stream transmission protocol in this embodiment is, for example, a QUIC Unidirection Stream, the unreliable datagram transmission protocol is, for example, a QUIC Datagrams, the bidirectional reliable stream transmission protocol is, for example, a QUIC Bidirection Stream, and the network transmission sending stream transmission protocol is, for example, a WebTransportSendStream.

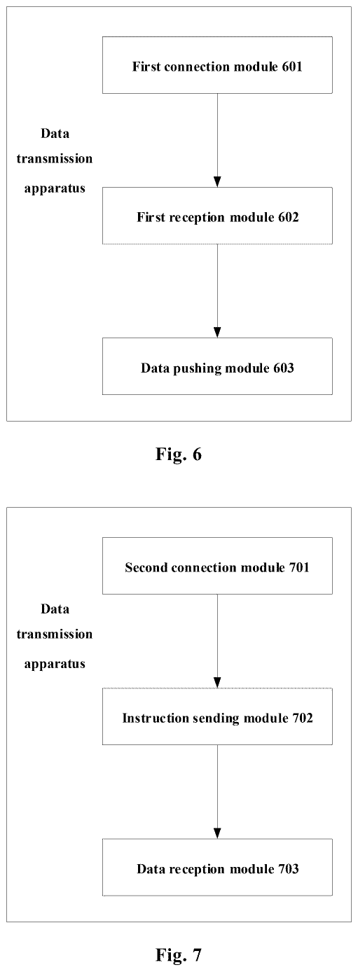

As shown in FIG. 6, based on the same inventive concept as the data transmission method applied to the server in the present disclosure, one or more embodiments of the present disclosure may further provide a data transmission apparatus, which is applied to the server.

The data transmission apparatus applied to the server includes but is not limited to a first connection module 601, a first reception module 602, and a data pushing module 603.

The first connection module 601 is configured to establish a network communication connection with a terminal device according to historical connection establishment information, wherein the historical connection establishment information is historical information for connection between the server and the terminal device.

The first reception module 602 is configured to receive a control instruction from the terminal device based on the network communication connection, wherein the control instruction is configured to control a process of a first application on the server, and the first application is a version of an application on the server.

The data pushing module 603 is configured to push, to the terminal device, a data stream corresponding to the control instruction based on the network communication connection, wherein the data stream is configured for loading and/or running a second application on the terminal device, and the second application is a version of the application on the terminal device.

Optionally, the data pushing module includes an acquisition module, a creation module, and a transmission module.

The acquisition module is configured to determine audio and video information, where the audio and video information is audio and video information in a process of the first application running according to the control instruction, and the audio and video information includes audio and video.

The creation module is configured to create a transmission stream based on the audio and video information, wherein the data stream includes the transmission stream.

The transmission module is configured to push the transmission stream to the terminal device based on the network communication connection.

Optionally, the creation module is configured to encode the audio and video information into a first transmission stream and a second transmission stream, where the first transmission stream is configured to be transmitted to the terminal device based on a reliable transmission manner, the second transmission stream is configured to be transmitted to the terminal device based on a non-reliable transmission manner, and the transmission stream includes the first transmission stream and the second transmission stream.

Optionally, the first transmission stream is an I frame transmission stream, and the I frame transmission stream is configured to be transmitted to the terminal device based on a first transmission protocol; and the second transmission stream is a P frame transmission stream, and the P frame transmission stream is configured to be transmitted to the terminal device based on a second transmission protocol; where a priority of the first transmission protocol is higher than a priority of the second transmission protocol.

Optionally, the data transmission apparatus further includes an instruction conversion module and a process control module.

The instruction conversion module is configured to convert the control instruction into a local instruction, wherein the local instruction is an instruction executed in the process of the first application.

The process control module is configured to control the process of the first application with the local instruction.

Optionally, the data transmission apparatus further includes an instruction sending module.

The instruction sending module is configured to send a specified instruction to the terminal device, wherein the specified instruction is configured to control a state of the second application.

Optionally, the first reception module 602 may be configured to receive the control instruction from the terminal device based on a third transmission protocol.

The data transmission apparatus further includes a file reception module.

The file reception module is configured to receive a file package from the terminal device based on a fourth transmission protocol, wherein a plurality of the file packages form a file uploaded by the terminal device.

The priority of the second transmission protocol is higher than the priority of the third transmission protocol, and the priority of the third transmission protocol is higher than the priority of the fourth transmission protocol.

Preferably, the first transmission protocol is a unidirectional reliable stream transmission protocol; and/or, the second transmission protocol is an unreliable datagram transmission protocol; and/or, the third transmission protocol is a bidirectional reliable stream transmission protocol; and/or, the fourth transmission protocol is a network transmission sending stream transmission protocol. The unidirectional reliable stream transmission protocol in this embodiment is, for example, a QUIC Unidirection Stream, the unreliable datagram transmission protocol is, for example, a QUIC Datagrams, the bidirectional reliable stream transmission protocol is, for example, a QUIC Bidirection Stream, and the network transmission sending stream transmission protocol is, for example, a WebTransportSendStream.

As shown in FIG. 7, based on the same inventive concept as the data transmission method applied to the server in the present disclosure, at least one embodiment of the present disclosure may further provide a data transmission apparatus, which is applied to a terminal device.

The data transmission apparatus applied to the terminal device includes but is not limited to a second connection module 701, an instruction sending module 702, and a data reception module 703.

The second connection module 701 is configured to establish a network communication connection with a server, wherein the network communication connection is established according to historical connection establishment information in the server, and the historical connection establishment information is historical information for connection between the server and the terminal device.

The instruction sending module 702 is configured to send a control instruction to the server based on the network communication connection, wherein the control instruction is configured to control a process of a first application on the server, and the first application is a version of an application on the server.

The data reception module 703 is configured to receive a data stream corresponding to the control instruction from the server based on the network communication connection, wherein the data stream is configured for loading and/or running a second application on the terminal device, and the second application is a version of the application on the terminal device.

Optionally, the server is configured to determine audio and video information, where the audio and video information is audio and video information in the process of the first application running according to the control instruction, and the audio and video information includes audio and video; the server is configured to create a transmission stream based on the audio and video information, where the data stream includes the transmission stream; and the server is configured to push the transmission stream to the terminal device based on the network communication connection. The server may be configured to determine the audio and video information by acquiring the audio and video information.

Optionally, the server is further configured to encode the audio and video information into a first transmission stream and a second transmission stream, where the first transmission stream is configured to be transmitted to the terminal device based on a reliable transmission manner, the second transmission stream is configured to be transmitted to the terminal device based on a non-reliable transmission manner, and the transmission stream includes the first transmission stream and the second transmission stream.

Optionally, the first transmission stream is an I frame transmission stream, and the I frame transmission stream is configured to be transmitted to the terminal device based on a first transmission protocol; and the second transmission stream is a P frame transmission stream, and the P frame transmission stream is configured to be transmitted to the terminal device based on a second transmission protocol; where a priority of the first transmission protocol is higher than a priority of the second transmission protocol.

Optionally, the server is configured to convert the control instruction into a local instruction, where the local instruction is an instruction executed in the process of the first application; and the server is configured to control the process of the first application with the local instruction.

Optionally, the data transmission apparatus further includes a second reception module.

The second reception module is configured to receive a specified instruction from the server, where the specified instruction is configured to control a state of the second application.

Optionally, the server is configured to receive the control instruction from the terminal device based on a third transmission protocol.

The data transmission apparatus further includes a file sending module.

The file sending module is configured to send a file package to the server based on a fourth transmission protocol, where a plurality of the file packages form a file uploaded by the terminal device.

The priority of the second transmission protocol is higher than the priority of the third transmission protocol, and the priority of the third transmission protocol is higher than the priority of the fourth transmission protocol.

Preferably, the first transmission protocol is a unidirectional reliable stream transmission protocol; and/or, the second transmission protocol is an unreliable datagram transmission protocol; and/or, the third transmission protocol is a bidirectional reliable stream transmission protocol; and/or, the fourth transmission protocol is a network transmission sending stream transmission protocol. The unidirectional reliable stream transmission protocol in this embodiment is, for example, a QUIC Unidirection Stream, the unreliable datagram transmission protocol is, for example, a QUIC Datagrams, the bidirectional reliable stream transmission protocol is, for example, a QUIC Bidirection Stream, and the network transmission sending stream transmission protocol is, for example, a WebTransportSendStream.

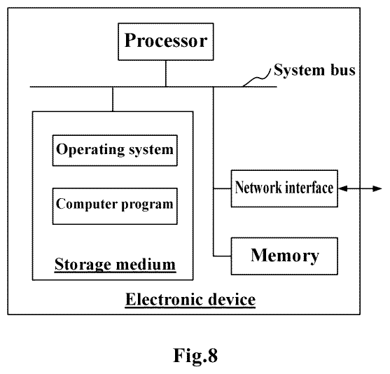

As shown in FIG. 8, based on the same inventive concept as the data transmission method applied to the server, at least one embodiment of the present disclosure can further provide an electronic device, including a memory and a processor, where the memory stores computer-readable instructions, and the computer-readable instructions, when executed by the processor, cause the processor to perform the data transmission method according to any embodiment of the present disclosure. The specific implementation process of the data transmission method has been described in detail in this specification, and will not be repeated here.

The electronic device includes a processor, a non-volatile storage medium, a memory, and a network interface, which are connected through a system bus. The non-volatile storage medium of the electronic device stores an operating system, a database, and computer-readable instructions, and the database may store a control information sequence. The computer-readable instructions, when executed by the processor, may cause the processor to implement a data transmission method. The processor of the electronic device is configured to provide computing and control capabilities to support the operation of the entire electronic device. The memory of the electronic device may store computer-readable instructions, and the computer-readable instructions, when executed by the processor, may cause the processor to execute a data transmission method. The network interface of the electronic device is configured to communicate with a terminal. It can be understood by those skilled in the art that the structure shown in FIG. 8 is only a block diagram of some structures related to the solution of the present disclosure, and does not constitute a limitation to the electronic device to which the solution of the present disclosure is applied. The specific electronic device may include more or fewer components than those shown in the figure, or may combine some components, or may have different component arrangements.

As shown in FIG. 8, based on the same inventive concept as the data transmission method applied to the server, at least one embodiment of the present disclosure can further provide a storage medium storing computer-readable instructions, and the computer-readable instructions, when executed by one or more processors, cause the one or more processors to execute the data transmission method according to any embodiment of the present disclosure. The specific implementation process of the data transmission method has been described in detail in this specification, and will not be repeated here.

All or part of the processes in the above embodiments may be completed by controlling relevant hardware through a computer program, where the computer program may be stored in a computer-readable storage medium, and the program, when executed, may include the processes of the above method embodiments. The logic and/or steps represented in the flowcharts or otherwise described herein may be considered as a definite sequence list of executable instructions for implementing the logical functions, and may be implemented in any computer-readable storage medium for use by an instruction execution system, apparatus, or device (such as a computer-based system, a system including a processor, or other systems that can fetch instructions from the instruction execution system, apparatus, or device and execute the instructions), or used in conjunction with these instruction execution systems, apparatus, or devices. For the purposes of this specification, a “computer-readable storage medium” may be any apparatus that can contain, store, communicate, propagate, or transmit a program for use by or in conjunction with the instruction execution system, apparatus, or device. More specific examples (a non-exhaustive list) of the computer-readable storage medium include: an electrical connection portion (electronic apparatus) with one or more wires, a portable computer disk cartridge (magnetic apparatus), a random-access memory (RAM), a read-only memory (ROM), an erasable programmable read-only memory (EPROM, or a flash memory), an optical fiber apparatus, and a portable compact disc read-only memory (CD-ROM). In addition, the computer-readable storage medium may even be a paper or other suitable medium on which the program can be printed, because the program can be obtained electronically, for example, by optically scanning the paper or other medium, and then editing, interpreting, or processing in other suitable ways if necessary, and then stored in a computer memory.

It should be understood that various parts of the present disclosure may be implemented in hardware, software, firmware, or a combination thereof. In the above implementations, multiple steps or methods may be implemented in software or firmware stored in the memory and executed by a suitable instruction execution system. For example, if implemented in hardware, as in another implementation, any one or a combination of the following techniques well-known in the art may be used: a discrete logic circuit having a logic gate circuit for implementing a logic function on a data signal, an application specific integrated circuit having a suitable combinational logic gate circuit, a programmable gate array (PGA), a field programmable gate array (FPGA), or the like.

In the description of this specification, the terms “this embodiment”, “one embodiment”, “some embodiments”, “example”, “specific example”, or “some examples” and the like mean that the specific features, structures, materials, or characteristics described in conjunction with the embodiment or example are contained in at least one embodiment or example of the present disclosure. In this specification, the schematic representations of the above terms are not necessarily directed to the same embodiment or example. Moreover, the specific features, structures, materials, or characteristics described may be combined in any one or more embodiments or examples in a suitable manner. In addition, those skilled in the art may combine and combine different embodiments or examples and features of different embodiments or examples described in this specification without contradiction.

Furthermore, the terms “first” and “second” are only used for descriptive purposes, and cannot be understood as indicating or implying relative importance or implicitly indicating the number of indicated technical features. Thus, features defined as “first” and “second” may explicitly or implicitly include at least one of the features. In the description of the present disclosure, “a plurality of” means at least two, for example, two, three, etc., unless specifically defined otherwise.

The above description is only preferred embodiments of the present disclosure, and is not intended to limit the present disclosure. Any modification, equivalent replacement, and simple improvement made on the substantial content of the present disclosure should be included in the protection scope of the present disclosure.

1. A data transmission method, applied to a server, wherein the data transmission method comprises:
establishing a network communication connection with a terminal device according to historical connection establishment information, wherein the historical connection establishment information is historical information for connection between the server and the terminal device;
receiving a control instruction from the terminal device based on the network communication connection, wherein the control instruction is configured to control a process of a first application on the server, and the first application is a version of an application on the server;
pushing, to the terminal device, a data stream corresponding to the control instruction based on the network communication connection, wherein the data stream is configured for at least one of loading or running a second application on the terminal device, and the second application is a version of the application on the terminal device.

2. The data transmission method according to claim 1, wherein the pushing the data stream corresponding to the control instruction to the terminal device based on the network communication connection comprises:
determining audio and video information, wherein the audio and video information is audio and video information in the process of the first application running according to the control instruction, and the audio and video information comprises audio and video;
creating a transmission stream based on the audio and video information, wherein the data stream comprises the transmission stream;
pushing the transmission stream to the terminal device based on the network communication connection.

3. The data transmission method according to claim 2, wherein the creating the transmission stream based on the audio and video information comprises:
encoding the audio and video information into a first transmission stream and a second transmission stream, wherein the first transmission stream is configured to be transmitted to the terminal device based on a reliable transmission manner, the second transmission stream is configured to be transmitted to the terminal device based on a non-reliable transmission manner, and the transmission stream comprises the first transmission stream and the second transmission stream.

4. The data transmission method according to claim 3, wherein
the first transmission stream is an I frame transmission stream, and the I frame transmission stream is configured to be transmitted to the terminal device based on a first transmission protocol;
the second transmission stream is a P frame transmission stream, and the P frame transmission stream is configured to be transmitted to the terminal device based on a second transmission protocol;
a priority of the first transmission protocol is higher than a priority of the second transmission protocol.

5. The data transmission method according to claim 1, wherein the method further comprises:
converting the control instruction into a local instruction, wherein the local instruction is an instruction executed in the process of the first application;
controlling the process of the first application with the local instruction.

6. The data transmission method according to claim 1, wherein the method further comprises:
sending a specified instruction to the terminal device, wherein the specified instruction is configured to control a state of the second application.

7. The data transmission method according to claim 4, wherein
the receiving the control instruction from the terminal device based on the network communication connection comprises: receiving the control instruction from the terminal device based on a third transmission protocol;
the method further comprises: receiving a file package from the terminal device based on a fourth transmission protocol, wherein a plurality of the file packages form a file uploaded by the terminal device;
wherein a priority of the second transmission protocol is higher than a priority of the third transmission protocol, and the priority of the third transmission protocol is higher than a priority of the fourth transmission protocol.

8. The data transmission method according to claim 7, wherein at least one of the following:
the first transmission protocol is a unidirectional reliable stream transmission protocol;
the second transmission protocol is an unreliable datagram transmission protocol;
the third transmission protocol is a bidirectional reliable stream transmission protocol; or
the fourth transmission protocol is a network transmission sending stream transmission protocol.

9. A data transmission method, applied to a terminal device, wherein the data transmission method comprises:
establishing a network communication connection with a server, wherein the network communication connection is established according to historical connection establishment information in the server, and the historical connection establishment information is historical information for connection between the server and the terminal device;
sending a control instruction to the server based on the network communication connection, wherein the control instruction is configured to control a process of a first application on the server, and the first application is a version of an application on the server;
receiving a data stream corresponding to the control instruction from the server based on the network communication connection, wherein the data stream is configured for at least one of loading or running a second application on the terminal device, and the second application is a version of the application on the terminal device.

10-11. (canceled)

12. An electronic device, comprising a memory and a processor, wherein the memory stores computer-readable instructions, and the computer-readable instructions, when executed by the processor, cause the processor to perform a data transmission method, applied to a server, wherein the data transmission method comprises:
establishing a network communication connection with a terminal device according to historical connection establishment information, wherein the historical connection establishment information is historical information for connection between the server and the terminal device;
receiving a control instruction from the terminal device based on the network communication connection, wherein the control instruction is configured to control a process of a first application on the server, and the first application is a version of an application on the server;
pushing, to the terminal device, a data stream corresponding to the control instruction based on the network communication connection, wherein the data stream is configured for at least one of loading or running a second application on the terminal device, and the second application is a version of the application on the terminal device.

13. A non-transitory computer-readable storage medium storing computer-readable instructions, wherein the computer-readable instructions, when executed by one or more processors, cause the one or more processors to perform the data transmission method according to claim 1.

14. (canceled)

15. The electronic device according to claim 12, wherein the pushing the data stream corresponding to the control instruction to the terminal device based on the network communication connection comprises:
determining audio and video information, wherein the audio and video information is audio and video information in the process of the first application running according to the control instruction, and the audio and video information comprises audio and video;
creating a transmission stream based on the audio and video information, wherein the data stream comprises the transmission stream;
pushing the transmission stream to the terminal device based on the network communication connection.

16. The electronic device according to claim 15, wherein the creating the transmission stream based on the audio and video information comprises:
encoding the audio and video information into a first transmission stream and a second transmission stream, wherein the first transmission stream is configured to be transmitted to the terminal device based on a reliable transmission manner, the second transmission stream is configured to be transmitted to the terminal device based on a non-reliable transmission manner, and the transmission stream comprises the first transmission stream and the second transmission stream.

17. The electronic device according to claim 16, wherein
the first transmission stream is an I frame transmission stream, and the I frame transmission stream is configured to be transmitted to the terminal device based on a first transmission protocol;
the second transmission stream is a P frame transmission stream, and the P frame transmission stream is configured to be transmitted to the terminal device based on a second transmission protocol;
a priority of the first transmission protocol is higher than a priority of the second transmission protocol.

18. The electronic device according to claim 12, wherein the method further comprises:
converting the control instruction into a local instruction, wherein the local instruction is an instruction executed in the process of the first application;
controlling the process of the first application with the local instruction.

19. The electronic device according to claim 12, wherein the method further comprises:
sending a specified instruction to the terminal device, wherein the specified instruction is configured to control a state of the second application.

20. The electronic device according to claim 17, wherein
the receiving the control instruction from the terminal device based on the network communication connection comprises: receiving the control instruction from the terminal device based on a third transmission protocol;
the method further comprises: receiving a file package from the terminal device based on a fourth transmission protocol, wherein a plurality of the file packages form a file uploaded by the terminal device;
wherein a priority of the second transmission protocol is higher than a priority of the third transmission protocol, and the priority of the third transmission protocol is higher than a priority of the fourth transmission protocol.

21. The electronic device according to claim 20, wherein at least one of the following:
the first transmission protocol is a unidirectional reliable stream transmission protocol;
the second transmission protocol is an unreliable datagram transmission protocol;
the third transmission protocol is a bidirectional reliable stream transmission protocol; or
the fourth transmission protocol is a network transmission sending stream transmission protocol.

22. An electronic device, comprising a memory and a processor, wherein the memory stores computer-readable instructions, and the computer-readable instructions, when executed by the processor, cause the processor to perform the data transmission method according to claim 9.

23. A non-transitory computer-readable storage medium storing computer-readable instructions, wherein the computer-readable instructions, when executed by one or more processors, cause the one or more processors to perform the data transmission method according to claim 9.
